(19) United States
(12) Patent Application Publication
(10) Pub. No.: US 2023/0220207 A1
(43) Pub. Date: Jul. 13, 2023

(54) Composition Comprising Polyester and Modified Softwood Lignin

(71) Applicant: LIGNIN INDUSTRIES AB, Knivsta (SE)

(72) Inventors: Christopher Carrick, Danderyd (SE); Marcus Ruda, Rimbo (SE); Johan Verendel, Uppsala (SE); Thomas Roulin, Solna (SE)

(21) Appl. No.: 17/928,914

(22) PCT Filed: May 31, 2021
(86) PCT No.: PCT/SE2021/050505

§ 371 Date: Nov. 30, 2022

(30) Foreign Application Priority Data
Jun. 2, 2020 (SE) 2030181-8

(51) Int. Cl. C08L 97/00; C08G 63/183; C08G 63/08; B29C 45/00; B29C 48/00

(52) U.S. Cl. CPC C08L 97/005; C08G 63/183; C08G 63/08; B29C 45/0001; B29C 48/022; B29C 2045/0091; C08L 2205/08; B29K 2067/003

(57) ABSTRACT

The present invention discloses a composition that may be extruded and/or injection moulded, comprising a chemically modified softwood lignin and a polyester selected from PBS (PolyButylene Succinate), PBAT (PolyButylene Adipate Terephthalate) and PCL (PolyCaproLactone) or mixtures thereof. The chemically modified softwood lignin constitutes 10 to 25 weight-% of the total weight of the composition.

### FIELD OF THE INVENTION

The present invention relates to a composition comprising polyester and chemically modified softwood lignin. The composition may be injection moulded.

### BACKGROUND

There is a need for more renewable plastic materials and lignin is a potential natural polymer to be used.

Lignin is the most available natural polymer next to cellulose. Lignin is found in the cell walls of fibrous plants and woods along with cellulose and hemicellulose. Lignin acts as a matrix material for polysaccharides, micro-fibrils and fibres and provides strength to plant stem. It is a high molecular weight phenolic macromolecule containing three different types of monolignol monomers p-coumaryl alcohol, coniferyl alcohol and sinapyl alcohol.

In recent years, much effort has been devoted to the development of new plastic materials being mixtures of well-known synthetic polymers, such as e.g. polyolefins, polyesters and polynitriles, and various forms of lignin. It follows that e.g. consumer products made of such mixtures are partly made of lignin. They may therefore be considered as more environmentally benign in comparison to the corresponding product made of a synthetic polymer, typically derived from non-recyclable fossil sources, as the only major constituent. Problems to be overcome with this type of mixtures include the relatively low general miscibility of lignin with various synthetic polymers, relatively low thermal stability of the intimate lignin and undesired properties of the resulting mixture, e.g. relatively low toughness, strain at break or tensile strength. Efforts have been devoted to addressing such problems by modification of the lignin employed, for example by adjustment of production parameters and by post-production chemical modification.

Polyester is a natural or synthetic polymer consisting of repeating units connected by an ester-group (—O—C[—O]—). Examples of thermoplastic synthetic polyesters include PolyButylene Adipate Terephthalate (PBAT), used e.g. as a biodegradable substitute for polyethylene in e.g. plastic bags and PolyButylene Succinate (PBS), often a material of choice for biodegradable plastic films. Additional examples of thermoplastic polyesters include PolyLactic Acid (PLA), employed as e.g. a plastic filament material, PolyCaproLactone (PCL), which may be used as e.g. an impact resistance increasing additive and PolyButylene Terephthalate (PBT), commonly used as e.g. electrical insulator.

WO2018/111183 A1 discloses a polymeric material comprising a first polymer and a modified lignin. It is taught therein that the first polymer may be a natural or synthetic polymer. Separate embodiments, being related to the first polymer, include polymers selected from the list of polymers consisting of polyolefins, polyesters and polynitriles. Disadvantages of polymeric materials of this type include a significant reduction in tensile strength and elongation of break as compared to the first polymer per-se.

In Tappi Journal, March 2017, No 3, 111-121, Glasser et al. discloses compostable films comprising biodegradable polyesters and a modified kraft lignin. The modified kraft lignin was obtained by O-alkylation of the corresponding lignin using propylene oxide as alkylating agent. Disadvantages of compostable films of this type include an unstable bubble in the melt-processing production of 12-14 μm films, when the content of the modified kraft lignin exceeds 30%.

U.S. Pat. No. 9,000,075 B2 discloses a composition comprising the reaction product resulting from a transesterification reaction between a hydroxypropyl lignin and a polyester. Disadvantages of such compositions include the need of extraordinary conditions, e.g. the employment of catalysts, suitable for formation of covalent bonds in the stage of the manufacturing process when the hydroxypropyl lignin and the polyester is brought in close proximity.

### SUMMARY OF THE INVENTION

The present invention discloses one or several solutions on how to overcome one or several of the drawbacks of the prior art as described above.

One aim of the present invention is to present a composition comprising a modified lignin, wherein this composition may be processed using conventional techniques such as extrusion, kneading, film blowing and injection moulding.

Another aim of the present invention is to disclose a composition comprising a modified lignin and a polyester, which composition is having such physical properties that a product made thereof may be used as a substitute for the corresponding product made of the polyester only.

Yet another aim of the present invention is to disclose a composition comprising a modified lignin and a polyester, which composition is having a toughness and/or a strain at break being comparable to or exceeding the corresponding toughness and/or strain at break of the polyester per-se.

In a first aspect, the present invention relates to a composition comprising a chemically modified softwood lignin and a polyester, wherein the chemically modified softwood lignin is carrying one or several of the O-substituents of Formula I-S to VI-S.

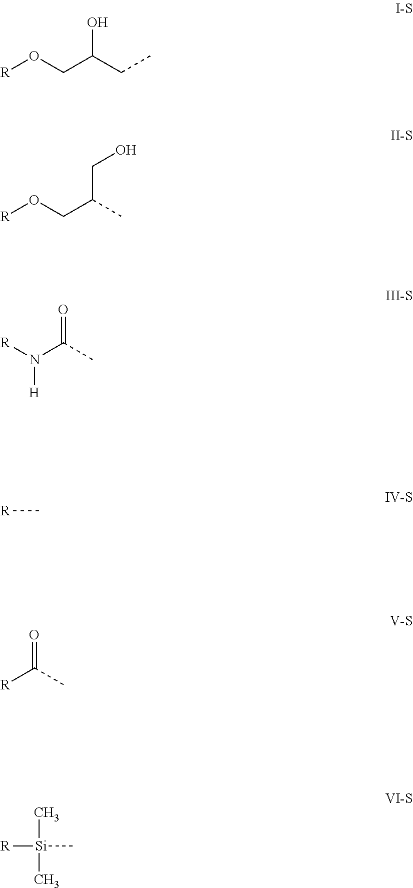

Hence, hydroxyl-groups of the softwood lignin is substituted and thus carrying one or several of the substituents of Formula I-S to VI-S by means of covalent bonds, indicated by a dashed line, originating at the hydroxyl oxygen atoms of the softwood lignin. The substituent R comprises at least 4 carbon atoms and the polyester being one or several of PLA, PCL, PBT, PEF, PHA, PHB, PBS and PBAT. The chemically modified softwood lignin constitutes 2 to 45 weight-% of the total weight of the composition.

In a second aspect, the present invention relates to a product which comprises the composition and which may be extruded and/or injection moulded.

In a third aspect, the present invention relates a method of extruding the composition, comprising the steps of mixing the chemically modified softwood lignin and the polyester and optionally a compatibilizer, to form a mixture; extruding the mixture at a temperature of at least 100° C. to form an extruded material; optionally cutting the extruded material into pellets; and optionally drying the extruded material.

In a forth aspect, the present invention relates a method of injection moulding the composition, comprising the steps of: providing pellets or powder of the composition; and injection moulding the pellets or powder into a desired shape at a temperature of at least 100° C.

All the embodiments herein are applicable to all the aspects.

### DETAILED DESCRIPTION OF THE INVENTION

In the present application the term “lignin” means a polymer comprising coumaryl alcohol, coniferyl alcohol and sinapyl alcohol monomers.

In the present application the term “linker” or “linker group” are used interchangeably and means any group which can connect lignin with a chemical group, e.g. a chemical group comprising an alkyl- or alkylene-fragment. It is to be understood that a part of the linker, e.g. an oxygen atom, may originate from lignin to form part of the linker itself after connection of a precursor, e.g. a synthetic intermediate, to lignin.

In the present application the term “compatibilizer” denotes a compound that promotes adhesion between polymers which otherwise are less compatible. Compatibilizers are widely used to increase the miscibility of otherwise immiscible polymers or polymers that do not mix so well.

In the present application, the term “softwood lignin” (SWL) is to be understood as a lignin which is derived from softwood, i.e. wood from gymnosperm trees.

Softwood and hardwood are distinguished botanically in terms of their reproduction, not by their end use or appearance. All trees reproduce by producing seeds, but the seed structure varies. In general, hardwood comes from a deciduous tree which loses its leaves annually and softwood comes from a conifer, which usually remains evergreen. Hardwoods tend to be slower growing and are therefore usually denser. Softwood trees are known as a gymnosperm. Gymnosperms reproduce by forming cones which emit pollen to be spread by the wind to other trees. A hardwood is an angiosperm, a plant that produces seeds with some sort of covering such as a shell or a fruit.

Examples of softwood trees include, but is not limited to, trees of genus Araucaria, e.g. hoop pine (Araucaria cunninghamii), monkey puzzle tree (Araucaria araucana) and parani pine (Araucaria angustifolia), trees of genus Cedar, e.g. atlas cedar (Cedrus atlantica), cyprus cedar (Cedrus brevifolia), himalayan cedar (Cedrus deodara), lebanon cedar (Cedrus libani), northern white cedar (Thuja occidentalis), atlantic white cedar (Chamaecyparis thyoides), eastern red cedar (Juniperus virginiana) and western red cedar (Thuja plicata), trees of family Cypress, e.g. arizona cypress (Cupressus arizonica), southern cypress (Taxodium distichum), alerce (Fitzroya cupressoides), hinoki cypress (Chamaecyparis obtusa), lawson's cypress (Chamaecyparis lawsoniana), mediterranean cypress (Cupressus sempervirens), nootka cypress (Cupressus nootkatensis), coast redwood (Sequoia sempervirens), sugi (Cryptomeria japonica), and rimu (Dacrydium cupressinum), trees of genus Douglas-fir, e.g. coast douglas-fir (Pseudotsuga menziesii var. menziesii) and rocky mountain douglas-fir (Pseudotsuga menziesii var. glauca), trees of family Taxaceae, e.g. european yew (Taxus baccata), trees of genus Fir, e.g. balsam fir (Abies balsamea), silver fir (Abies alba), noble fir (Abies procera) and pacific silver fir (Abies amabilis), trees of genus Hemlock, e.g. eastern hemlock (Tsuga canadensis), mountain hemlock (Tsuga mertensiana), western hemlock (Tsuga heterophylla), huon pine, macquarie pine (Lagarostrobos franklinii), kauri (Agathis australis), queensland kauri (Agathis robusta), japanese nutmeg-yew and kaya (Torreya nucifera), trees of genus Larch, e.g. european larch (Larix decidua), japanese larch (Larix kaempferi), tamarack (Larix laricina) and western larch (Larix occidentalis), trees of genus Pine, e.g. european black pine (Pinus nigra), jack pine (Pinus banksiana), lodgepole pine (Pinus contorta), monterey pine (Pinus radiata), ponderosa pine (Pinus ponderosa), red pine (Pinus resinosa), eastern white pine (Pinus strobus), western white pine (Pinus monticola), sugar pine (Pinus lambertiana), loblolly pine (Pinus taeda), longleaf pine (Pinus palustris), pitch pine (Pinus rigida) and shortleaf pine (Pinus echinata) and trees of genus Spruce, e.g. norway spruce (Picea abies), black spruce (Picea mariana), red spruce (Picea rubens), sitka spruce (Picea sitchensis) and white spruce (Picea glauca).

In the present application, the term “softwood kraft lignin” (SWKL) is to be understood as a subset of SWL, wherein the SWKL is produced by taking the black liquor from the Kraft process and precipitating the lignin by lowering the pH, as well known to the skilled person, according to, for example, the Lignoboost process, the SLRP process or the LignoForce process.

In the present application, the term “softwood organosolv lignin” (SWOL) is to be understood as a subset of SWL, wherein the SWOL is produced by extraction of lignin and hemicelluloses from the wood by help of an organic solvent, such as e.g. acetone, methanol, ethanol, butanol, ethylene glycol, formic acid or acetic acid, as well known by the skilled person. The wood may be pretreated with base, acid or enzyme (cellulases). The lignin may be separated from the solvent and hemicelluloses by precipitation, e.g. by adding water and sometimes also by lowering the pH simultaneously.

In the present application, the term “softwood soda pulping lignin” (SWSPL) is to be understood as a subset of SWL, wherein the SWSPL is produced by precipitation of the black liquor the soda pulping process and lowering the pH, e.g. according to the Lignoboost process, the SLRP process or the LignoForce process, as well known to the skilled person.

### Lignin

The lignin, useful for the production of a composition of the present invention, may be obtained from any suitable form of softwood, such as e.g. saw dust or wood chips. An illustration of lignin, comprising the text “LIG”, is depicted below (hydroxyl groups not shown).

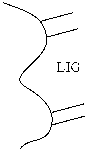

It is preferred that the softwood contains as much lignin as possible. The Kappa number estimates the amount of chemicals required during bleaching of wood pulp in order to obtain a pulp with a given degree of whiteness. Since the amount of bleach needed is related to the lignin content of the pulp, the Kappa number can be used to monitor the effectiveness of the lignin-extraction phase of the pulping process. It is approximately proportional to the residual lignin content of the pulp.

K≈c*l

K: Kappa number; c: constant≈6.57 (dependent on process and wood); l: lignin content in percent. The Kappa number is determined by ISO 302:2004. The kappa number may be 20 or higher, or 40 or higher, or 60 or higher. In one embodiment, the kappa number is 10-100.

The softwood material may be a mixture of softwood materials and in one embodiment the softwood material is black or red liquor, or materials obtained from black or red liquor. Black and red liquor contains cellulose, hemi cellulose and lignin and derivatives thereof. The SWL, useful for the production of a composition of the present invention, may comprise black or red liquor, or lignin obtained from black or red liquor.

Black liquor comprises four main groups of organic substances, around 30-45 weight % ligneous material, 25-35 weight % saccharine acids, about 10 weight % formic and acetic acid, 3-5 weight % extractives, about 1 weight % methanol, and many inorganic elements and sulphur. The exact composition of the liquor varies and depends on the cooking conditions in the production process and the feedstock. Red liquor comprises the ions from the sulfite process (calcium, sodium, magnesium or ammonium), sulfonated lignin, hemicellulose and low molecular resins.

The lignin, useful for the production of a composition of the present invention, is essentially a SWL, such as for example a SWKL. In one embodiment, the lignin may be a SWL selected from the group of SWL's consisting of SWKL, SWOL and SWSPL. In one embodiment, the lignin may be a SWL selected from the group of SWL's consisting of Lignoboost® lignin, precipitated lignin, filtrated lignin, acetosolv lignin, lignin from soda pulping or organosolv lignin. In another embodiment the lignin may be SWKL. In another embodiment the lignin may be organosolv lignin. The lignin may be in particulate form with a particle size of 5 mm or less, or 1 mm or less.

Native lignin or Kraft lignin is not soluble in most organic solvents, fatty acids or oils. Instead prior art has presented various techniques to depolymerize and covert the depolymerized lignin into components soluble in the wanted media.

The weight average molecular weight (mass) (M_{w}) of the lignin, useful for the production of a composition of the present invention, may be 30,000 g/mol or less, such as not more than 20,000 g/mol, or not more than 10,000 g/mol, or not more than 5,000 g/mol, or not more than 2,000 g/mol, but preferably higher than 1,000 g/mol, or higher than 1,200 g/mol, or higher than 1,500 g/mol. In one embodiment the number average molecular weight of the lignin is between 1,000 and 4,000 g/mol, or between 1,500 and 3,500 g/mol.

### Modified or Derivatized Lignin

The lignin, useful for the production of a composition of the present invention, is essentially modified or derivatized with a chemical group R comprising at least 4 carbon atoms. The group R may be, but is not limited to, an alkyl group, such as e.g. C₁₀-C₂₀-alkyl or C₁₂-C₁₇-alkyl, an aryl group, such as phenyl, or —(CH₂CH₂O)ₙCH₂CH₂Oalk, wherein n is 1 to 180 and alk is H, methyl or ethyl. The group R may be saturated, unsaturated, straight, branched, cyclic and it may be further substituted with small substituents, such as e.g. OH, NH2, COOH, COO-alkyl or methyl. The group R is essentially connected to the lignin via a linker group L, comprising 0 to 3 carbon atoms, 1 to 3 oxygen atoms and 0 to 1 nitrogen atoms. The linker group L may be derived from a hydroxyl group of the lignin. Hence, the linker L may comprise an oxygen-atom, which typically may originate from the original lignin. The linker L may be connected to an aryl group or an aliphatic part on the lignin according to the schematic chemical structures 1 and 2:

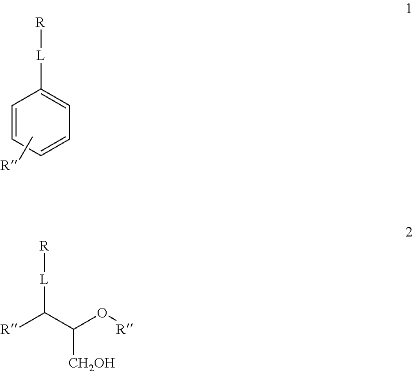

In formula 1 and 2 above, the lignin is schematically represented by the R″ and the aryl or aliphatic groups respectively, L is the linker and R is a chemical group as mentioned and explained herein. Since lignin has aliphatic hydroxyl groups as well as aromatic hydroxyl groups, the linker L may be attached to an aliphatic part of lignin (structure 2). The linker L may also be connected direct to the aryl group in lignin (structure 1). R″ may be hydrogen, alkyl, aryl or alkoxy group or any other group found in lignin. The aryl group of the lignin may comprise more than one R″.

The degree of modification of the hydroxyl groups of the lignin, useful for the production of a composition of the present invention, may be expressed as number of equivalents to lignin repeating units. The number of equivalents may be 0.01 or higher, 0.05 or higher, 0.1 or higher, 0.2 or higher, or 0.4 or higher, or 0.6 or higher, or 0.8 or higher. In this application the repeating unit of lignin is assumed to have a molecular weight of 180 g/mol. The degree of modification of the lignin when the lignin is chemically modified may be quite low and still be miscible with the first polymer. In one embodiment the number of equivalents may be 0.01-0.2, such as 0.05-0.2 or 0.1-0.15.

The lignin, useful for the production of a composition of the present invention, is essentially a SWL, such as for example a SWKL, a SWOL or a SWSPL.

According to one embodiment, the linker L may be a chemical group comprising 3 carbon atoms and 3 oxygen atoms. For example, the lignin, e.g. a SWKL, a SWOL or a SWSPL, may be modified with groups R linked to the lignin via an alkylene glycol linkage, i.e. a —OCH2CH(OH)CH2O— group as depicted in Formula I or a —OCH2CH(CH2OH)O— group as depicted in Formula II. The linker L of the modified lignin may be O-substituted at one of the oxygen atoms with the group R. The oxygen atom of the linker L, being bond to or part of lignin in the modified lignin, may originate from the original lignin, i.e. lignin prior to any modification yielding modified lignin. Alternatively, the oxygen atom of the linker L, being bond to or part of lignin in the modified lignin, may originate from a chemical reactant, from which the linker L is formed upon chemical reaction with lignin.

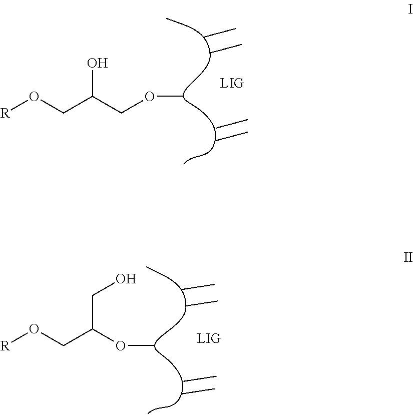

The modified lignin of formula I or II, may be produced or synthesized by the reaction between a compound according to formula SM2 and lignin (hydroxyl groups not shown) as depicted below. The compound according to formula SM2 may be synthesized directly by reaction of a compound according to formula SM1 and epichlorohydrin, or alternatively via the corresponding epoxide opened product followed by intra-molecular re-formation of the epoxide by displacement of the intermediate chloride, as well known in the art and as depicted below. The compound according to formula SM2 may also be synthesized by O-allylation of the compound of formula SM1, e.g. with allyl bromide, followed by oxidation, e.g. with a peracid, as well known in the art. The compound according to formula SM2 may be generated in situ in presence of lignin, when producing or synthesizing a modified lignin of formula I or II of the present invention.

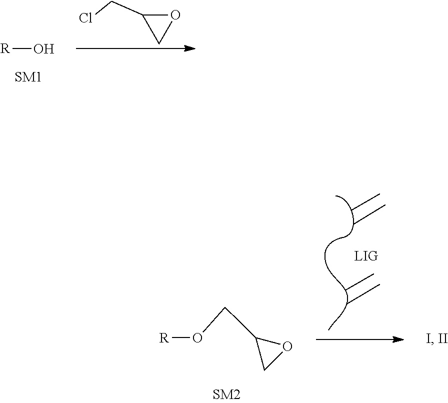

The R-group of the modified SWL according to formula I or formula II of the present invention may be a straight, cyclic, branched, saturated or unsaturated alkyl group comprising 4 to 36 carbon atoms, such as e.g. 4 to 25, 14 to 18, 12 to 15 or 12 to 14 carbon atoms. The R-group of the modified SWL according to formula I or formula II of the present invention may be independently selected from the group consisting of saturated alkyl, unsaturated alkyl, straight alkyl, branched alkyl and cyclic alkyl. Such an alkyl group may be further substituted with substituents independently selected from the group consisting of —OH, —NH2, —COOH, aryl and phenyl. Such an alkyl group may further incorporate one or more fragment selected from the group of fragments selected from —COO—, —S— and —O—. The R-group of the modified SWL according to formula I or formula II of the present invention may be independently selected from the group consisting of phenyl, ortho-methyl phenyl, para-methyl phenyl, cyclohexyl, 4-tertbutyl phenyl, 2-ethyl hexyl, cardanyl and nonylphenyl. The R-group of the modified SWL according to formula I or formula II of the present invention may be independently selected from the group consisting of compounds of formula S1, S2, S3, S4, S5 and S6 as depicted below. The integer n of compounds of formula S1, S2, S3, S4, S5 and S6 may be 1-180, 1-100, 1-50, 1-25, 1-10, 1-5 or 1-2.

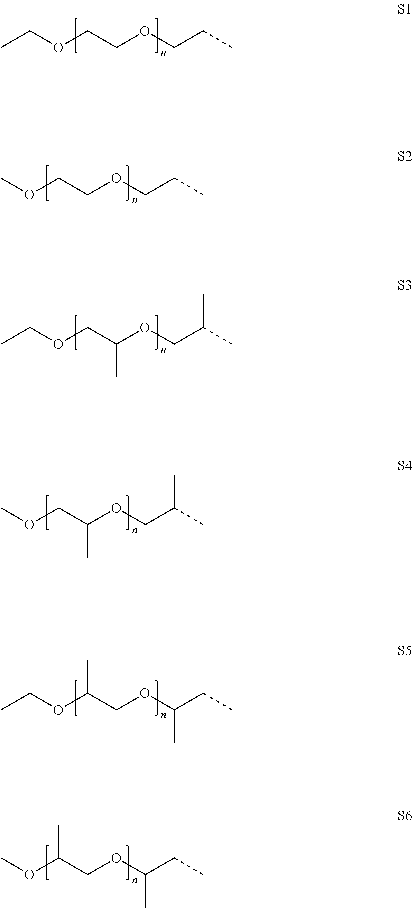

The R-group of the modified SWL according to formula I or formula II of the present invention may comprise a plurality of different R-groups. For example, such modified lignin may be prepared as taught herein from reaction with 2 to 20%, such as 6%, cresyl glycidyl ether and 2 to 15%, such as 6%, C₁₂-C₁₄-glycidyl ether.

According to one embodiment, the linker L may comprise 1 carbon atom, one nitrogen atom and 2 oxygen atoms, such as e.g. when being a carbamate group. For example, the lignin, e.g. a SWKL, a SWOL or a SWSPL, may be modified with groups R linked to the lignin via a carbamate moiety, i.e. a —NHC(═O)O— group as depicted in formula III. The oxygen atom of the linker L, being bond to or part of lignin in the modified lignin, may originate from the original lignin, i.e. lignin prior to any modification yielding modified lignin. Alternatively, the oxygen atom of the linker L, being bond to or part of lignin in the modified lignin, may originate from a chemical reactant, from which the linker L is formed upon chemical reaction with lignin.

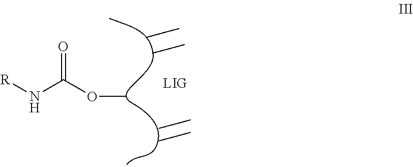

The modified lignin of formula III, may be produced or synthesized by the reaction between an isocyanate according to formula SM3 and lignin (hydroxyl groups not shown) as depicted below. U.S. Pat. No. 3,072,634 (A) discloses examples of detailed descriptions on the synthesis of compounds according to formula III.

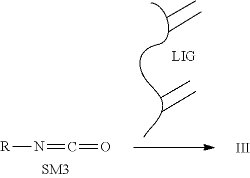

The R-group of the modified SWL according to formula III of the present invention may be a straight, cyclic, branched, saturated or unsaturated alkyl group comprising 4 to 36 carbon atoms, such as e.g. 4 to 25, 14 to 18, 12 to 15 or 12 to 14 carbon atoms, benzyl and phenyl. Such an R-group may be further substituted with substituents independently selected from the group consisting of, aryl, phenyl and ester. Such an R-group may further incorporate one or more fragment selected from the group of fragments selected from —COO—, —S— and —O—. The R-group of the modified SWL according to formula III of the present invention may be independently selected from the group consisting of phenyl, cyclohexyl and octadecyl. The R-group of the modified SWL according to formula III of the present invention may be independently selected from the group consisting of compounds of formula S1, S2, S3, S4, S5 and S6 as depicted above. The integer n of compounds of formula S1, S2, S3, S4, S5 and S6 may be 1-180, 1-100, 1-50, 1-25, 1-10, 1-5 or 1-2.

The R-group of the modified SWL according to formula III of the present invention may comprise a plurality of different R-groups. Such a plurality may be selected from two, three or more R-groups from the list consisting of saturated alkyl, unsaturated alkyl, straight alkyl, branched alkyl and cyclic alkyl. The alkyl group may be further substituted with substituents independently selected from the group consisting of aryl, phenyl, and epoxide. The alkyl group may incorporate one or more fragment selected from the group of fragments selected from —COO—, —S— and —O—.

According to one embodiment, the linker L may be an oxygen atom. For example, the lignin, e.g. a SWKL, a SWOL or a SWSPL, may be modified with groups R linked to the lignin via an oxygen atom, i.e. a —O— group as depicted in formula IV. The oxygen atom of the linker L, being bond to or part of lignin in the modified lignin, may originate from the original lignin, i.e. lignin prior to any modification yielding modified lignin. Alternatively, the oxygen atom of the linker L, being bond to or part of lignin in the modified lignin, may originate from a chemical reactant, from which the linker L is formed upon chemical reaction with lignin.

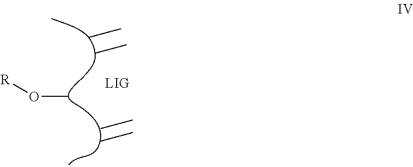

The modified lignin of formula IV, may be produced or synthesized by the reaction between an electrophile according to formula SM4, carrying a leaving group X, e.g. chloride, bromide, mesylate or the like, and lignin (hydroxyl groups not shown) as depicted below. In Ind. Eng. Chem. Res. 2012, 51, 51, 16713-16720, syntheses of compounds of formula IV are disclosed.

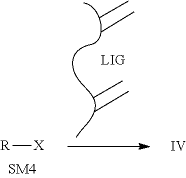

The R-group of the modified SWL according to formula IV of the present invention may be a straight, cyclic, branched, saturated or unsaturated alkyl group comprising 4 to 36 carbon atoms, such as e.g. 4 to 25, 14 to 18, 12 to 15 or 12 to 14 carbon atoms. The R-group of the modified SWL according to formula IV of the present invention may be saturated alkyl, unsaturated alkyl, straight alkyl, branched alkyl and cyclic alkyl. Such an R-group may be further substituted with substituents independently selected from the group consisting of —OH, —NH2, —COOH, aryl and phenyl. Such an R-group may further incorporate one or more fragment selected from the group of fragments selected from —COO—, —S— and —O—. The R-group of the modified SWL according to formula IV of the present invention may be independently selected from the group consisting of benzyl, ortho-methyl benzyl, para-methyl benzyl, cyclohexyl, 4-tertbutyl benzyl, 2-ethyl hexyl and nonylphenyl. The R-group of the modified SWL according to formula IV of the present invention may be independently selected from the group consisting of compounds of formula S1, S2, S3, S4, S5 and S6 as depicted above. The integer n of compounds of formula S1, S2, S3, S4, S5 and S6 may be 1-180, 1-100, 1-50, 1-25, 1-10, 1-5 or 1-2.

The R-group of the modified SWL according to formula IV of the present invention may comprise a plurality of different R-groups. Such a plurality may be selected from two, three or more R-groups from the list consisting of saturated alkyl, unsaturated alkyl, straight alkyl, branched alkyl and cyclic alkyl. The alkyl group may be further substituted with substituents independently selected from the group consisting of aryl, phenyl, benzyl and allyl. The alkyl group may incorporate one or more fragment selected from the group of fragments selected from —COO—, —S— and —O—.

According to one embodiment, the linker L may comprise 1 carbon atom and two oxygen atoms, such as e.g. when being an ester group. For example, the lignin, e.g. a SWKL, a SWOL or a SWSPL, may be modified with groups R linked to the lignin via an ester moiety, i.e. a —C(═O)O— group as depicted in formula V. The oxygen atom of the linker L, being bond to or part of lignin in the modified lignin, may originate from the original lignin, i.e. lignin prior to any modification yielding modified lignin. Alternatively, the oxygen atom of the linker L, being bond to or part of lignin in the modified lignin, may originate from a chemical reactant, from which the linker L is formed upon chemical reaction with lignin.

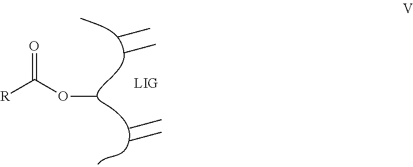

The modified lignin of formula V may be produced or synthesized by the reaction between a compound according to formula SM5, SM6 or SM7 and lignin (hydroxyl groups not shown) as depicted below. In US2016355535A, it is taught how compounds according to formula V may be synthesized from the corresponding lignin.

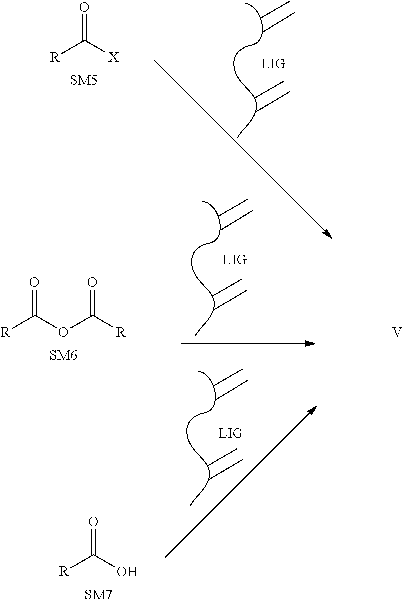

The R-group of the modified SWL according to formula V of the present invention may be a straight, cyclic, branched, saturated or unsaturated alkyl group comprising 4 to 36 carbon atoms, such as e.g. 4 to 25, 14 to 18, 12 to 15 or 12 to 14 carbon atoms. The R-group of the modified SWL according to formula V of the present invention may be saturated alkyl, unsaturated alkyl, straight alkyl, branched alkyl and cyclic alkyl. Such an alkyl group may be further substituted with substituents independently selected from the group consisting of —OH, —NH2, —COOH, aryl, phenyl, benzyl and allyl. Such an R-group may be further substituted with substituents independently selected from the group consisting of aryl and phenyl. Such an R-group may further incorporate one or more fragment selected from the group of fragments selected from —COO—, —S— and —O—. The R-group of the modified SWL according to formula V of the present invention may be independently selected from the group consisting of phenyl, ortho-methyl phenyl, para-methyl phenyl, cyclohexyl, 4-tertbutyl phenyl, 2-ethyl hexyl, octadecyl and benzyl. The R-group of the modified SWL according to formula V of the present invention may be independently selected from the group consisting of compounds of formula S1, S2, S3, S4, S5 and S6 as depicted above. The integer n of compounds of formula S1, S2, S3, S4, S5 and S6 may be 1-180, 1-100, 1-50, 1-25, 1-10, 1-5 or 1-2.

The R-group of the modified SWL according to formula V of the present invention may comprise a plurality of different R-groups. Such a plurality may be selected from two, three or more R-groups from the list consisting of saturated alkyl, unsaturated alkyl, straight alkyl, branched alkyl and cyclic alkyl. The alkyl group may be further substituted with substituents independently selected from the group consisting of aryl, phenyl, benzyl and allyl. The alkyl group may incorporate one or more fragment selected from the group of fragments selected from —COO—, —S— and —O.

According to one embodiment, the linker L may comprise 2 carbon atoms and one oxygen atom, such as when being a dimethylsilyloxy group. For example, the lignin, e.g. a SWKL, a SWOL or a SWSPL, may be modified with groups R linked to the lignin via a dimethylsilyloxy moiety, i.e. a —Si(Me)₂O-group as depicted in formula VI. The oxygen atom of the linker L, being bond to or part of lignin in the modified lignin, may originate from the original lignin, i.e. lignin prior to any modification yielding modified lignin. Alternatively, the oxygen atom of the linker L, being bond to or part of lignin in the modified lignin, may originate from a chemical reactant, from which the linker L is formed upon chemical reaction with lignin.

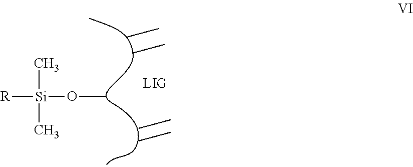

The modified lignin of formula VI may be produced or synthesized by the reaction between a compound according to formula SM8, in which X may be a halide such as e.g. Cl, and lignin (hydroxyl groups not shown) as depicted below. In ACS Sustainable Chem. Eng. 2016, 4, 10, 5212-5222 it is taught how a compound of formula VI may be synthesized from the corresponding lignin.

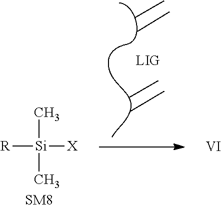

The R-group of the modified SWL according to formula VI of the present invention may be a straight, cyclic, branched, saturated or unsaturated alkyl group comprising 4 to 36 carbon atoms, such as e.g. 4 to 25, 14 to 18, 12 to 15 or 12 to 14 carbon atoms. The R-group of the modified SWL according to formula VI of the present invention may be saturated alkyl, unsaturated alkyl, straight alkyl, branched alkyl and cyclic alkyl. Such an alkyl group may be further substituted with substituents independently selected from the group consisting of aryl, phenyl, benzyl and allyl. Such an R-group may be further substituted with substituents independently selected from the group consisting of aryl and phenyl. Such an R-group may further incorporate one or more fragment selected from the group of fragments selected from —COO—, —S— and —O—. The R-group of the modified SWL according to formula VI of the present invention may be independently selected from the group consisting of phenyl, ortho-methyl phenyl, para-methyl phenyl, tertbutyl, methyl, cyclohexyl, 4-tertbutyl phenyl, 2-ethyl hexyl, octadecyl, dodecyl and benzyl. The R-group of the modified SWL according to formula VI of the present invention may be independently selected from the group consisting of compounds of formula S1, S2, S3, S4, S5 and S6 as depicted above. The integer n of compounds of formula S1, S2, S3, S4, S5 and S6 may be 1-180, 1-100, 1-50, 1-25, 1-10, 1-5 or 1-2.

The R-group of the modified SWL according to formula VI of the present invention may comprise a plurality of different R-groups. Such a plurality may be selected from two, three or more R-groups from the list consisting of saturated alkyl, unsaturated alkyl, straight alkyl, branched alkyl and cyclic alkyl. The alkyl group may be further substituted with substituents independently selected from the group consisting of aryl, phenyl, benzyl and allyl. The alkyl group may incorporate one or more fragment selected from the group of fragments selected from —COO—, —S— and —O—.

The composition according to the present invention may be prepared by first preparing the lignin that is modified or derivatized with a group R via a linker L, followed by mixing the modified lignin with a polyester, such as e.g. PET, PBAT, PLA, PCL, PBT, PolyEthylene 2,5-Furandicarboxylate (PEF), PolyHydroxyAlkanoate (PHA), PolyHydroxyButyrate (PHB) or PBS. The modification may be done in a suitable solvent. The modified lignin may be isolated from the modification reaction mixture or the modified lignin may be left in the reaction mixture when mixed with the polyester, such as e.g. PBAT, PLA, PCL, PBT, PEF, PHA, PHB or PBS. The mixing can be done by stirring or shaking or in any other suitable way and the slurry may then be heated. Any catalyst and any other unwanted components may be removed afterwards using any suitable technique.

The composition according to the present invention may alternatively be prepared by simultaneously reacting the lignin with a suitable reagent, to attach a group R via a linker L as taught herein, while mixing with a polyester, such as e.g. PBAT, PLA, PCL, PBT, PEF, PHA, PHB or PBS.

The chemical modification of the lignin, e.g. SWL or SWKL, may be performed at 60° C. and 250° C., such as 60° C. or higher, 80° C. or higher, or 100° C. or higher, or 120° C. or higher, or 150° C. or higher, or 160° C. or higher, or 180° C. or higher, but preferably not higher than 250° C.

### The Composition Comprising Chemically Modified SWL and Polyester

The present invention relates to a composition comprising a polyester and a chemically modified SWL. The composition is essentially a mixture between a polyester, e.g. PLA, PCL, PBT, PEF, PHA, PHB, PBS or PBAT, and a chemically modified SWL, e.g. a SWKL, according to Figure I, II, III, IV, V, VI or mixtures thereof. The modification yielding the modified SWL may be done by allowing the SWL to react with suitable reagents as taught elsewhere herein.

It was surprisingly found that compositions of the invention have one or several advantageous physicochemical properties, such as e.g. tensile strength, film forming properties, such as e.g. the formation of films being less or equal than/to 20 μm or 12 μm and elongation of break, as compared to the corresponding pure polyester per-se or corresponding compositions of the prior-art. In light of the present prior-art, further detailed herein before, one or several such physicochemical properties of mixtures of chemically modified lignin and polyesters are expected to be less advantageous as compared to the corresponding pure polyester.

The optimal range of the chemically modified SWL in a composition of the invention may be 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the composition of the invention.

In a composition of the invention, the polyester may typically constitute essentially the rest of the total weight of the composition, when the weight of the chemically modified SWL has been subtracted. The sum of the singularity or plurality of polyesters and the singularity or plurality of chemically modified SWL may constitute more than 90 weight-%, such as more than 95, 98 or 99 weight-% of the total weight of the composition. The remaining 10, 5, 2 and 1 weight-%, respectively, may be constituted by one or several of suitable fillers, compatibilizers or the like.

The advantageous physicochemical properties of a composition of the invention may include, without being limited thereto, a singularity or plurality of a group of properties consisting of strain at break, young's modulus, film forming properties and toughness.

According to one embodiment, the composition of the invention may comprise a chemically modified SWL being a mixture of compounds according to Formula I and II and a polyester being selected from the group of polyesters consisting of PLA, PCL, PBT, PEF, PHA, PHB, PBS and PBAT. The substituent R of Formula I and II may be selected from C₄-C₂₅-alkyl, CH[(CH₂)ₘCH₃]CH(OH)(CH₂)ₘC(═O)OC₁₋₃alkyl, CH[CH(OH)(CH₂)ₘCH₃](CH2)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl and compounds of formula S1, S2, S3, S4, S5 and S6, wherein the integer m may be 3 to 10 and the integer n may be 1 to 180. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula III and a polyester being selected from the group of polyesters consisting of PLA, PCL, PBT, PEF, PHA, PHB, PBS and PBAT. The substituent R of Formula III may be selected from C₄-C₂₅-alkyl, CH[(CH₂)ₘCH₃]CH(OH)(CH₂)ₘC(═O)OC₁₋₃alkyl, CH[CH(OH)(CH₂)ₘCH₃](CH₂)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl and compounds of formula S1, S2, S3, S4, S5 and S6, wherein the integer m may be 3 to 10 and the integer n may be 1 to 180. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula IV and a polyester being selected from the group of polyesters consisting of PLA, PCL, PBT, PEF, PHA, PHB, PBS and PBAT. The substituent R of Formula IV may be selected from C₄-C₂₅-alkyl, CH[(CH₂)ₘCH₃]CH(OH)(CH₂)ₘC(═O)OC₁₋₃alkyl, CH[CH(OH)(CH₂)ₘCH₃](CH₂)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl and compounds of formula S1, S2, S3, S4, S5 and S6, wherein the integer m may be 3 to 10 and the integer n may be 1 to 180. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula V and a polyester being selected from the group of polyesters consisting of PLA, PCL, PBT, PEF, PHA, PHB, PBS and PBAT. The substituent R of Formula V may be selected from C₄-C₂₅-alkyl, phenyl, ortho-methyl phenyl, para-methyl phenyl, cyclohexyl, 4-tertbutyl phenyl, 2-ethyl hexyl, cardanyl and nonylphenyl. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula VI and a polyester being selected from the group of polyesters consisting of PLA, PCL, PBT, PEF, PHA, PHB, PBS and PBAT. The substituent R of Formula VI may be selected from C₄-C₂₅-alkyl, phenyl, ortho-methyl phenyl, para-methyl phenyl, cyclohexyl, 4-tertbutyl phenyl, 2-ethyl hexyl, cardanyl and nonylphenyl. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula I, II or IV and a polyester being selected from the group of polyesters consisting of PBS and PBAT. The substituent R of the compound according to Formula I, II or IV may be selected from C₄-C₂₅-alkyl, CH[(CH₂)ₘCH₃]CH(OH)(CH₂)ₘC(═O)OC₁₋₃alkyl, CH[CH(OH)(CH₂)ₘCH₃](CH₂)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl and compounds of formula S1, S2, S3, S4, S5 and S6, wherein the integer m may be 3 to 10 and the integer n may be 1 to 180. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula I, II or IV and a polyester being selected from the group of polyesters consisting of PBS, PBAT and PCL. The substituent R of the compound according to Formula I, II or IV may be selected from C₄-C₂₅-alkyl, CH[(CH₂)ₘCH₃]CH(OH)(CH₂)ₘC(═O)OC₁₋₃alkyl, CH[CH(OH)(CH₂)ₘCH₃](CH₂)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl, wherein the integer m may be 3 to 10. The composition may comprise 10 to 25 weight-% of the SWL. Advantages of such a composition include an improved strain at break as compared to the polyester per-se.

According to one embodiment, the composition of the invention may comprise a chemically modified SWL being a compound according to Formula IV and a polyester being selected from the group of polyesters consisting of PBS and PBAT. The substituent R of the compound according to Formula IV may be selected from CH[(CH₂)ₘCH₃]CH(OH)(CH₂)ₘC(═O)OC₁-3alkyl and CH[CH(OH)(CH₂)ₘCH₃](CH₂)ₘC(═O)OC₁₋₃alkyl, wherein the integer m may be 3 to 10. The composition may comprise 10 to 25 weight-% of the SWL. Advantages of such a composition include an improved strain at break as compared to the polyester per-se.

According to one embodiment, the composition of the invention may comprise a chemically modified SWL being a compound according to Formula I and/or II and a polyester being PCL. The substituent R of the compound according to Formula I and/or II may be selected from C₄-C₂₅-alkyl, phenyl, ortho-methyl phenyl, para-methyl phenyl, cyclohexyl, 4-tertbutyl phenyl, 2-ethyl hexyl, cardanyl, nonylphenyl, such as from C₄-C₂₅-alkyl and ortho-methyl phenyl. The composition may comprise 10 to 25 weight-% of the SWL. Advantages of such a composition include an improved strain at break as compared to the polyester per-se.

According to one embodiment, the composition of the invention may comprise a chemically modified SWL being a compound according to Formula I or II, or mixtures thereof, and a polyester being selected from the group of polyesters consisting of PBS and PBAT. The substituent R of the compound according to Formula I or II may be selected from C₄-C₂₅-alkyl, phenyl, ortho-methyl phenyl, para-methyl phenyl, cyclohexyl, 4-tertbutyl phenyl, 2-ethyl hexyl, cardanyl and nonylphenyl. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

According to one embodiment, the composition of the invention may comprise a chemically modified SWL being a compound according to Formula IV and a polyester being selected from the group of polyesters consisting of PBS and PBAT. The substituent R of the compound according to Formula IV may be selected from CH[(CH₂)ₘCH₃]CH(OH)(CH₂)ₘC(═O)OC₁₋₃alkyl and CH[CH(OH)(CH₂)ₘCH₃](CH₂)ₘC(═O)OC₁₋₃alkyl, wherein the integer m may be 3 to 10. The composition may comprise 2 to 45 weight-%, such as 2 to 40 weight-%, 2 to 35 weight-%, such as 5 to 30 weight-%, 5 to 25 weight-%, 10 to 35 weight-%, 10 to 30 weight-% or 10 to 25 weight-% of the SWL. Advantages of such a composition include an improved strain at break as compared to the polyester per-se.

A study showed that the composition of the invention could be processed through extrusion and injection moulding, even without any added compatibilizer. The modified SWL could be compounded together with the polyester followed by extrusion at sufficiently high temperatures such as at above 100° C., e.g. 110-250° C., 130-240° C., 140-220° C., 140-200° C., 140-190° C. or 140-180° C. The extrusion can be done using a twin-screw extruder. The obtained extruded product may be turned into pellets or powder which may then be dried using any suitable technique.

Injection moulding of the present composition may also be done at temperatures above 100° C., such as above 110° C. or even at 200° C. or higher without any increase in viscosity or pressure. In one embodiment the temperature is 110-250° C. The starting material for the injection moulding may be the pellets or powder obtained from the extrusion described above. Injection moulding facilitates that the more complex shapes and structures may be prepared from the present material.

According to one embodiment, the composition of the present invention may be extruded or injection moulded to yield a physical product. Such physical product may have a pre-defined shape as dependent on the production thereof and as well understood by the skilled artisan. Such a physical product may be produced by extrusion by mixing a first polymer, further described herein, the modified lignin of the present invention and optionally a compatibilizer, to form a mixture. This mixture may be extruded at a temperature of at least 100° C., preferably at least 170° C. or at least 250° C., to form an extruded material. This extruded material may then optionally be cut prior to drying.

According to one embodiment, the composition of the present invention may be injection molded. For example, a powder or pellets of the composition may be molded into a desired shape at a temperature of at least 100° C., or preferably at least 180° C. or at least 250° C.

According to one embodiment, the modified SWL of the present invention may be thermally stable at temperatures up to 150° C., or up to 180° C., or up to 200° C., or up to 220° C., or up to 240° C.

According to one embodiment, the modified SWL of the present invention may be employed as the only constituent or one of the constituents of a compatibilizer. For example, the modified SWL may be mixed with polymers or mixtures of polymers in solution, dry state or in melt.

### Examples

### Materials

The lignin (SWKL) used in the present examples was derived from spruce black liquor from the Kraft process where the lignin precipitated by using the Ligno Boost process followed by drying to generate a Lignin powder. The C12-C14-glycidyl ether oil (Cas #68609-97-2) was purchased from AL.P.A.S. s.r.l. The 9,10-epoxy-octadecanoic acid methyl ester oil was produced inhouse by peroxidation of methyl oleate (purity 90%) which was purchased from Chemtronica AB (Sweden).

### Preparation of Chemically Modified SWL's (Examples 1:1 to 1:3:2)

### Example 1:1: Preparation of a Mixture of Chemically Modified SWKL Consisting of a Compound According to Formula IV, Wherein R is CH[(CH₂)₇CH₃]CH(OH)(CH₂)₇C(═O)OCH₃ and a Compound According to Formula IV, Wherein R is CH[CH(OH)(CH₂)₇CH₃](CH₂)₇C(═O)OCH3, by Reaction in an Extruder, where Premixed Lignin-Oil Mixture was Used

Extruder: LabTech Twin screw-extruder; Screw diameter=20 mm, L/D=48; the screw profile has transport elements from barrel 1-3, from barrel 4 to 10 transport and kneading elements, and from barrel 11-12 transport element that builds up pressure to the die Motor power=5.5 kW. 2.64 kg of Lignin (water content of 4%) powder and 360 g (0,086 mol eq.) of 9,10-epoxy-octadecanoic acid methyl ester oil (epoxidized Fatty acid methyl ester; epoxy FAME) was premixed prior to feeding into the extruder. The screw speed was set at 90 rpm. The processing temperature was set as followed: feeding barrel section no heating, 2nd barrel section 80° C., 3^{rd} barrel section 150° C., 4^{th} barrel section 170° C., 5^{th}-12^{th} barrel sections 190° C. and the die 175° C. A 400 mbar vacuum was applied at barrel section 11 to remove moisture and volatiles. The two black viscous strands were collected out of the die head.

### Example 1:2:1: Preparation of a Chemically Modified SWKL According to Formula I and II Wherein R is C₁₂-C₁₄-Alkyl by Reaction in an Extruder

Extruder: LabTech Twin screw-extruder; Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW

2.64 kg of Lignin powder and 360 g (0,033 mol eq.) of C₁₂-C₁₄-glycidyl ether oil was premixed prior to feeding into the extruder. The screw speed was set at 350 rpm. The processing temperature was set as followed: 1a barrel section equipped with a side feeder 80° C. (Lignin oil feeding), 2^{nd} barrel section 80° C., 3^{rd} barrel section 150° C., 4^{t} barrel section 170° C., 5^{th}-15^{th} barrel and the die sections 190° C. The 10^{t} barrel was equipped with an atmospheric vent port. A 400 mbar vacuum was applied at barrel section 14 to remove moisture and volatiles. The two black viscous strands were collected out of the die head.

### Example 1:2:2: Preparation of a Chemically Modified SWKL According to Formula I and II Wherein R is C₁₂-C₁₄-Alkyl by Reaction in an Extruder

Extruder: LabTech Twin screw-extruder; Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW

2.4 kg of Lignin powder and 600 g (0,058 mol eq.) of C₁₂-C₁₄-glycidyl ether oil was premixed prior to feeding into the extruder. The screw speed was set at 350 rpm. The processing temperature was set as followed: 1a barrel section equipped with a side feeder 80° C. (Lignin feeding), 2nd barrel section equipped with liquid dosing port 80° C. (oil feeding), 3^{rd} barrel section 150° C., 4^{th} barrel section 170° C., 5^{th}-15^{th} barrel and the die sections 190° C. The 10^{th} barrel was equipped with an atmospheric vent port. A 400 mbar vacuum was applied at barrel section 14 to remove moisture and volatiles. The two black viscous strands were collected out of the die head.

### Example 1:3:1: Preparation of a Chemically Modified SWKL According to Formula I and II Wherein R is Ortho-Cresyl by Reaction in an Extruder, where Premixed Lignin-Oil Mixture was Used

Extruder: LabTech Twin screw-extruder; Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW

2.64 kg of Lignin powder and 360 g (0,156 mol eq.) of O-Cresyl glycidyl ether oil was premixed before feeding into the extruder. The screw speed was set at 350 rpm. The processing temperature was set as followed: feeding barrel section no heat, 1a barrel section equipped with a side feeder 80° C. (Lignin feeding), 2^{nd} barrel section equipped with liquid dosing port 80° C. (oil feeding), 3^{rd} barrel section 150° C., 4^{th} barrel section 170° C., 5^{th}-15^{th} barrel and the die sections 190° C. The 10^{th} barrel was equipped with an atmospheric vent port. A 400 mbar vacuum was applied at barrel section 14 to remove moisture and volatiles. The two black viscous strands were collected out of the die head.

### Example 1:3:2: Preparation of a Chemically Modified SWKL According to Formula I and II Wherein R is Ortho-Methyl Phenyl, i.e. Ortho-Cresyl, by Reaction in an Extruder, where Premixed Lignin-Oil Mixture was Used

Extruder: LabTech Twin screw-extruder; Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW

2.4 kg of Lignin powder and 600 g (0,274 mol eq.) of O-Cresyl glycidyl ether oil was premixed before feeding into the extruder. The screw speed was set at 350 rpm. The processing temperature was set as followed: feeding barrel section no heat, 1a barrel section equipped with a side feeder 80° C. (Lignin feeding), 2^{nd} barrel section equipped with liquid dosing port 80° C. (oil feeding), 3^{rd} barrel section 150° C., 4^{th} barrel section 170° C., 5^{th}-15^{th} barrel and the die sections 190° C. The 10^{th} barrel was equipped with an atmospheric vent port. A 400 mbar vacuum was applied at barrel section 14 to remove moisture and volatiles. The two black viscous strands were collected out of the die head.

### Production of Compositions Comprising Chemically Modified SWL's and Polyesters (Examples 2:1 to 2:13)

### Example 2:1 Production of a Composition Comprising 10 Weight-% of a Chemically Modified SWKL According to Formula P and 90 Weight-% of a Polyester being PBS

Polybutylene succinate (PBS) (BioPBS FD72PM from PTT MCC Biochem Company Ltd) was compounded with 10 wt. % of modified lignin from Example 1:1, in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:2 Production of a Composition Comprising 25 Weight-% of a Chemically Modified SWKL According to Formula P and 75 Weight-% of a Polyester being PBS

Polybutylene succinate (PBS) (BioPBS FD72PM from PTT MCC Biochem Company Ltd) was compounded with 25 wt. % of modified lignin from Example 1:1, in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:3 Production of a Composition Comprising 50 Weight-% of a Chemically Modified SWKL According to Formula IV and 50 Weight-% of a Polyester being PBS

Polybutylene succinate (PBS) (BioPBS FD72PM from PTT MCC Biochem Company Ltd) was compounded with 50 wt. % of modified lignin from Example 1:1, in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:4 Production of a Reference Material of the Polyester PBS

Polybutylene succinate (PBS) (BioPBS FD72PM from PTT MCC Biochem Company Ltd) was compounded in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:5 Production of a Composition Comprising 10 Weight-% of a Chemically Modified SWKL According to Formula P and 90 Weight-% of a Polyester being PBAT

Polybutylene adipate terephthalate (PBAT) (Ecoworld™ 003) was compounded with 10 wt. % of modified lignin from Example 1:1, in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:6 Production of a Composition Comprising 40 Weight-% of a Chemically Modified SWKL According to Formula P and 60 Weight-% of a Polyester being PBAT

Polybutylene adipate terephthalate (PBAT) (Ecoworld™ 003) was compounded with 40 wt. % of modified lignin from Example 1:1, in a LabTech Twin screw-extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:7 Production of a Reference Material of the Polyester PBAT

Polybutylene adipate terephthalate (PBAT) (Ecoworld™ 003) was compounded in a LabTech Twin screw=extruder (Screw diameter=20 mm, L/D=48; Motor power=5.5 kW; the screw profile has transport elements from barrel 1-3, from barrel 4 to 10 transport and kneading elements, and from barrel 11-12 transport element that builds up pressure to the die). The total feeding rate of the materials was set to 3 kg/h and the screw speed set to 90 rpm. The processing temperature was set as followed: feeding barrel section no heat, 1st barrel section 80° C., 2nd barrel section 150° C., 3rd-11th barrel sections 170° C., and the die 180° C. The two strands from the die head was cooled on an air-cooled conveyer (2.6 m, 8 fans, steel mesh conveyer belt) and then pelletized in a strand pelletizer.

### Example 2:8 Production of a Composition Comprising 25 Weight-% of a Chemically Modified SWKL According to Formula I and II from Example 1:2:1 with 75 Weight-% of a Polyester being PBAT

Polybutylene adipate terephthalate (PBAT) (Ecoworld™ 003) was compounded with 25 wt. % of modified lignin from Example 1:2:1 in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1a barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

### Example 2:8:1 Production of a Composition Comprising 25 Weight-% of a Chemically Modified SWKL According to Formula I and II from Example 1:2:2 with 75 Weight-% of a Polyester being PBAT

Polybutylene adipate terephthalate (PBAT) (Ecoworld™ 003) was compounded with 25 wt. % of modified lignin from Example 1:2:2 the same machine, settings, and procedure as in Example 2:8.

### Example 2:8:2 Production of a Composition Comprising 25 Weight-% of a Chemically Modified SWKL According to Formula I and II from Example 1:3:1 with 75 Weight-% of a Polyester being PBAT

Polybutylene adipate terephthalate (PBAT) (Ecoworld™ 003) was compounded with 25 wt. % of modified lignin from Example 1:3:1 with the same machine, settings, and procedure as in Example 2:8.

### Example 2:9 Production of a Composition Comprising 25 Weight-% of a Chemically Modified SWKL According to Formula I and II from Example 1:3:2 with 75 Weight-% of a Polyester being PBAT

Polybutylene adipate terephthalate (PBAT) (Ecoworld™ 003) was compounded with 25 wt. % of modified lignin from Example 1:3:2 with the same machine, settings, and procedure as in Example 2:8.

### Example 2:10 Production of a Composition Comprising 25 Weight-% of a Chemically Modified SWKL According to Formula I and II from Example 1:2:1 with 75 Weight-% of a Polyester being PBS

Polybutylene succinate (PBS) (BioPBS FD72PM from PTT MCC Biochem Company Ltd) was compounded with 25 wt. % of modified lignin from Example 1:2:1 with the same machine, settings, and procedure as in Example 2:8.

### Example 2:11 Production of a Composition Comprising 25 Weight-% of a Chemically Modified SWKL According to Formula I and II from Example 1:2:2 with 75 Weight-% of a Polyester being PBS

Polybutylene succinate (PBS) (BioPBS FD72PM from PTT MCC Biochem Company Ltd) was compounded with 25 wt. % of modified lignin from Example 1:2:2 with the same machine, settings, and procedure as in Example 2:8.

### Example 2:12 Production of a Composition Comprising 25 Weight-% of a Chemically Modified SWKL According to Formula I and II from Example 1:3:1 with 75 Weight-% of a Polyester being PBS

Polybutylene succinate (PBS) (BioPBS FD72PM from PTT MCC Biochem Company Ltd) was compounded with 25 wt. % of modified lignin from Example 1:3:1 with the same machine, settings, and procedure as in Example 2:8.

### Example 2:13 Production of a Composition Comprising 25 Weight-% of a Chemically Modified SWKL According to Formula I and II from Example 1:3:2 with 75 Weight-% of a Polyester being PBS

Polybutylene succinate (PBS) (BioPBS FD72PM from PTT MCC Biochem Company Ltd) was compounded with 25 wt. % of modified lignin from Example 1:3:2 with the same machine, settings, and procedure as in Example 2:8.

### Example 2:14 Production of a Composition Comprising 20 Weight-% of a Chemically Modified SWKL According to Formula I and II from Example 1:2:1 with 80 Weight-% of a Polyester being PBAT

Polybutylene adipate terephthalate (PBAT) (Ecoworld™ 003) was compounded with 20 wt. % of modified lignin from Example 1:2:1 in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1a barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

### Example 2:15 Production of a Composition Comprising 20 Weight-% of a Chemically Modified SWKL According to Formula I and II from Example 1:2:1 with 80 Weight-% of a Polyester being PCL

Polycaprolactone (PCL) (Ingevity™ CAPA 6500) was compounded with 20 wt. % of modified lignin from Example 1:2:1 in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1^{st} barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

### Example 2:16 Production of a Composition Comprising 30 Weight-% of a Chemically Modified SWKL According to Formula I and II from Example 1:2:1 with 70 Weight-% of a Polyester being PCL

Polycaprolactone (PCL) (Ingevity™ CAPA 6500) was compounded with 30 wt. % of modified lignin from Example 1:2:1 in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1a barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

### Example 2:17 Production of a Reference Material of the Polyester PCL

Polycaprolactone (PCL) (Ingevity™ CAPA 6500) was compounded in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1a barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

### Example 2:18 Production of a Composition Comprising 20 Weight-% of a Chemically Modified SWKL According to Formula I and II from Example 1:3:1 with 80 Weight-% of a Polyester being PBAT

Polybutylene adipate terephthalate (PBAT) (Ecoworld™ 003) was compounded with 20 wt. % of modified lignin from Example 1:3:1 in a LabTech Twin screw-extruder (Screw diameter=20 mm, L/D=60; the screw profile has transport elements from barrel 1-3, from barrel 4 to 13 transport and kneading elements, and from barrel 14-15 transport element that builds up pressure to the die; Motor power=11 kW). The total feeding rate of the materials was set to 4 kg/h and the screw speed set to 350 rpm. The processing temperature was set as followed: 1^{st} barrel section equipped with a side feeder 80° C. (Lignin feeding), 2^{nd}-3^{rd} barrel section 150° C., 4^{th}-15^{th} barrel and the die sections 190° C. The two strands from the die head was cooled on an air-cooled conveyer (2.6 m, 8 fans, steel mesh conveyer belt) and then pelletized in a strand pelletizer.

Physicochemical Properties of Compositions of the Invention and Comparison with the Corresponding Polyesters

Pellets from Example 2:1 to 2:7 and 2:14 to 2:18 were each melted to a puck of 15 g. The puck was pressed to film in a hot press. The hot press was equipped a die with a circular hole in the middle, where the hole's dimension was 1 mm thick and 20 cm in diameter. The hot press was first heated to 165° C. and then a pressure was applied of 15 bar for 10 seconds followed by an increase of pressure to 50 bar for 10 seconds and finally a pressure of 100 bar was applied for 30 seconds. Strips with a width of 15 mm were cut from the films.

The strips were conditioned overnight in a climate room at 23° C. and 50% Relative Humidity (RH). The tensile testing was done in the same climate room at same temperature and RH. The speed of the testing was set to 50 mm/min. The distance between the grips, where the strips was clamped to the machine, was 50 mm.

| | Composition | | | | | |
|---|---|---|---|---|---|---|
| | Polyester/ | Modified | | | | |
| | Proportion | lignin | | | | |
| | of | (structure #)/ | | | | |
| | compo- | Proportion | Youngs | | | Strain |
| | sition | of | mod- | Tensile | Tough- | at |
| | (weight- | composition | ulus | strenght | ness | Break |
| Example | %) | (weight-%) | (MPa) | (MPa) | (MJ/m³) | (%) |
| Example | PBS/90 | IV/10 | 212.42 | 23.00 | 146.58 | 885 |
| 2:1 | | | | | | |
| Example | PBS/75 | IV/25 | 293.08 | 18.50 | 104.77 | 847 |
| 2:2 | | | | | | |
| Example | PBS/50 | IV/50 | 530.78 | 13.83 | 1.56 | 17 |
| 2:3 | | | | | | |
| Example | PBS/100 | — | 224.52 | 23.93 | 147.41 | 822 |
| 2:4 | | | | | | |
| Example | PBAT/ | IV/10 | 59.55 | 21.87 | 103.41 | 821 |
| 2:5 | 90 | | | | | |
| Example | PBAT/ | IV/40 | 196.89 | 14.6 | 63.28 | 651 |
| 2:6 | 60 | | | | | |
| Example | PBAT/ | — | 22.57 | 58.53 | 105.52 | 809 |
| 2:7 | 100 | | | | | |
| Example | PBAT/ | I and II/20 | | 16.55 | | 931.55 |
| 2:14 | 80 | | | | | |
| Example | PCL/80 | I and II/20 | | 18.4 | | 1014.4 |
| 2:15 | | | | | | |
| Example | PCL/70 | I and II/30 | | 8.94 | | 305.8 |
| 2:16 | | | | | | |
| Example | PCL/100 | | | 17.1 | | 882.67 |
| 2:17 | | | | | | |
| Example | PBAT/ | I and II/20 | | 16.93 | | 1056.61 |
| 2:18 | 80 | | | | | |

The results in the table above shows that compositions comprising a polyester and 10 or 25 weight-% of a chemically modified SWL (Examples 2:1, 2:2 and 2:5 and 2:14, 2:15 and 2:18), surprisingly has a Strain at Break which exceeds the same of the corresponding pure polyester (Examples 2:3 and 2:6 and 2:17).

1. A composition comprising a chemically modified softwood lignin and a polyester, wherein
said chemically modified softwood lignin is carrying one or several 0-substituents of Formula I-S, II-S and IV-S; 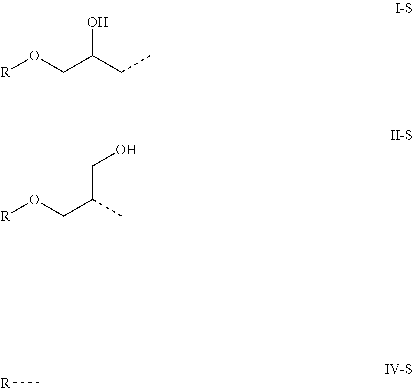
R being independently selected from:
C₄-C₂₅-alkyl, CH[(CH₂)ₘCH₃]CH(OH)(CH₂)ₘC(═O)OC₁₋₃ alkyl, CH[CH(OH)(CH₂)ₘCH₃](CH₂)ₘC(═O)OC₁₋₃alkyl, phenyl, ortho-methyl phenyl, para-methyl phenyl, cyclohexyl, 4-tertbutyl phenyl, 2-ethyl hexyl, cardanyl, nonylphenyl, wherein the integer m is 3 to 10;
said polyester being selected from PBS (PolyButylene Succinate), PBAT (PolyButylene Adipate Terephthalate) and PCL (PolyCaproLactone) or mixtures thereof; and
said chemically modified softwood lignin constitutes 10 to 25 weight-% of the total weight of said composition.

2. A composition according to claim 1, wherein
said chemically modified softwood lignin is carrying one or several O-substituents of Formula IV-S;
R being independently selected from CH[(CH₂)ₘCH₃]CH(OH)(CH₂)ₘC(═O)OC₁₋₃alkyl and CH[CH(OH)(CH₂)ₘCH₃](CH₂)ₘC(═O)OC₁₋₃alkyl, wherein the integer m is 3 to 10; and
said polyester being selected from PBS (PolyButylene Succinate) and PBAT (PolyButylene Adipate Terephthalate) or mixtures thereof.

3. A composition according to claim 1, wherein
said chemically modified softwood lignin is carrying one or several O-substituents of Formula I-S and II-S, or mixtures thereof,
R being independently selected from C₄-C₂₅-alkyl, phenyl, ortho-methyl phenyl, para-methyl phenyl, cyclohexyl, 4-tertbutyl phenyl, 2-ethyl hexyl, cardanyl, nonylphenyl; and
said polyester being PCL (PolyCaproLactone).

4. A composition according to claim 3, wherein R being independently selected from C₄-C₂₅-alkyl and ortho-methyl phenyl.

5. A composition according to claim 1, wherein said chemically modified softwood lignin is derived from a softwood lignin selected from a softwood kraft lignin (SWKL), a softwood organosolv lignin (SWOL) and a softwood soda pulping lignin (SWSPL).

6. A composition according to claim 1, wherein essentially the rest of the total weight of said composition, beside said chemically modified softwood lignin, being said polyester.

7. A product extruded and/or injection molded and comprising said composition according to claim 1.

8. A method of extruding said composition according to claim 1, comprising the steps of:
mixing said chemically modified softwood lignin and said polyester and optionally a compatibilizer, to form a mixture;
extruding said mixture at a temperature of at least 100° C. to form an extruded material;
optionally cutting said extruded material into pellets; and
optionally drying said extruded material.

9. A method of injection molding said composition according to claim 1, comprising the steps of:
providing pellets or powder of said composition; and
injection molding said pellets or powder into a desired shape at a temperature of at least 100° C.
